(19) United States
(12) Patent Application Publication
(10) Pub. No.: US 2009/0278880 A1
(43) Pub. Date: Nov. 12, 2009

(54) INK JET DEVICE FOR PRODUCING A BIOLOGICAL ASSAY SUBSTRATE BY RELEASING A PLURALITY OF SUBSTANCES ONTO THE SUBSTRATE, AND METHOD FOR MONITORING THE INK JET DEVICE

(75) Inventors: Johan Frederik Dijksman, Weert (NL); Anke Pierik, Eindohoven (NL); Martin Maurice Vernhout, Geldrop (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/304,198

(22) PCT Filed: May 14, 2007
(86) PCT No.: PCT/IB07/51815

§ 371 Date: Dec. 10, 2008

(30) Foreign Application Priority Data
Jun. 13, 2006 (EP) 06115369.8

(51) Int. Cl. B41J 29/38; B41J 2/045

(52) U.S. Cl. 347/14; 347/71

(57) ABSTRACT

The invention provides an ink jet device for producing a biological assay substrate by releasing a plurality of substances onto the substrate, the device comprising at least a print head comprising a nozzle, the device comprising at least a transducer provided to eject a droplet out of the nozzle, wherein a detection means is assigned to the ink jet device such that the state of the print head can be monitored by means of the detection of the behaviour of to the transducer.

The present invention relates to an ink jet device for producing a biological assay substrate by depositing a plurality of substances onto the substrate. The present invention further relates to a method for monitoring the state of the print head of the ink jet device. The present invention also relates to the use of an ink jet device.

The present invention discloses an ink jet device for producing a biological assay substrate by depositing a plurality of substances onto a substrate, a method and the use of an ink jet device. Especially for diagnostics, substrates are needed where a plurality of preferably different substances are positioned in a very precise and accurate manner. This plurality of substances are usually to be positioned on a substrate in order to perform a multitude of biochemical tests or reactions on the substrate. The ink jet device, the method for controlled positioning of droplets of a substance and the use of an ink jet device according to the present invention are preferably applied to the printing process of substances onto a substrate, where it is extremely hazardous if a substance of a certain kind is applied wrongly onto a certain region of the substrate, such as is the case in diagnostics.

The diagnostics of infectious diseases demands for a very high reliability of the printing process of the capture probes. The read-out of the assay substrate for instance relates diseases directly to the positions of the specific capture probes. It is therefore important to be able to position the capture probes on the membrane reliably and correctly. Although inkjet printing is known as a precision dosing technique it generally does not incorporate any feedback about the actual presence and placements of the droplets on the substrate. Information about the course of the process is generally not available. Known methods to control inkjet printer operation are described in European patent applications EP 1378359 A1, EP 1378360 A1, EP 1378361 A1. These documents disclose methods of controlling an inkjet print head containing ink where an actuation pulse is applied by an electro-mechanic transducer in order to eject an ink drop or droplet out of a duct, wherein an electronic circuit is used to measure the impedance of the electro-mechanic transducer and to adapt the actuation pulse or a subsequent actuation pulse according to this measurement. If a print head fails droplets may not be produced at all or droplets may leave the print head according to a flight path, which differs, from the predetermined flight path. This is noticeable after production of the substrate only, and moreover only by methods, which at least partially destroy the functionality of the produced substrate. This strongly limits the reliability of the printing or ink jet device especially for applications where a reliable printing process using a plurality of different substances is essential.

It is therefore an objective of the present invention to provide an ink jet device and method for producing a biological assay substrate by depositing a plurality of substances onto the substrate, which device and method allow to continuously monitor the state of the printing process.

The above objective is accomplished by an ink jet device for producing a biological assay substrate by depositing a plurality of substances onto a substrate, by a method for monitoring the state of the print head according to the present invention and by the use of an ink jet device according to the present invention. The ink jet device thereto comprises at least a print head comprising a nozzle, and at least a transducer provided to eject a droplet out of the nozzle, whereby a detection means is assigned to the ink jet device such that the state of the print head can be monitored by means of the detection of the behaviour of the transducer.

It is an advantage of the ink jet device according to the present invention that it becomes possible to monitor the state of the printing process, and more in particular the state of the print head by means of a measurement of the behaviour of the transducer and/or of the transducer comprising the substance. The transducer is a—preferably electromechanical—transducer applying mechanical and hydro-acoustical waves into the print head. The print head is preferably an almost closed volume at least partially filled with the liquid to be print, i.e. the substance to be printed. The print head comprises at least one opening or a duct where upon an actuation pulse at least a part of the liquid contained in the print head can be expelled or ejected forming outside of the print head a droplet of the liquid. As the amount of liquid contained in the print head may be small the print head is usually connected to a reservoir either directly or via a small channel to avoid cross-talk from neighbouring nozzles and to make the print head less sensitive to vibrations coming from the environment or the motion of the stages. In the following, the opening or the duct is also called a nozzle in the context of the present invention. The opening to the reservoir is referred to as the throttle. By means of applying mechanical and hydro-acoustical waves into the print head filled with the liquid to print, the system comprising the print head and the liquid is reacting in a different manner if the state of the print head has changed and/or is changing over time. Some changes may occur gradually over time. The device according to the invention has the additional advantage that failures occurring in the printing process and in particular failures of the print head may be predicted from changes in the detected behaviour of the transducer. In the context of this application the terminology “state of the print head” should be interpreted to include a plurality of properties, such as the extent of filling of the print head and/or the liquid reservoir, the presence of air bubbles in the printable liquid, and the value of the under pressure used to maintain the correct position of the meniscus in the nozzle and to avoid flooding of the nozzle. Although many properties may be measured it is preferred according to the invention to monitor the degree of filling of the reservoir of a print head of the inkjet device and/or measuring the under pressure for controlling the meniscus position in the nozzle. According to the invention, the behaviour of the transducer which is indicative of the behaviour of the print head and/or of the behaviour of the system comprising the print head and the substance inside the print head is measured by a suitable parameter or parameters. If changes do occur in the state of the print head or printing process in general, the measured parameter(s) will also change. Discrimination between correct and incorrect functioning of the ink jet device, and accordingly of the printing process, now becomes possible upon assigning limit values to the measured parameter. The limit value demarcates correct from incorrect operation.

According to a preferred embodiment of the ink jet device according to the invention, the state of the print head is monitored by means of a measurement of the deformation of the transducer. It turned out that many properties of the print head do influence deformation of the transducer, and measurement of this deformation therefore enables to readily capture changes in the state of the print head.

In a particularly preferred ink jet device the state of the print head is monitored by means of a measurement of the deformation of the transducer upon ejecting the droplet out of the nozzle, preferably in both the time and frequency domain. When receiving a fire pulse, the piezoelectric actuator of the ink jet printer acts upon the fluid inside the print head such that a droplet is emitted. Apart from emitting droplets the fire pulse sets the fluid inside the print head and the surrounding structure into motion.

In a preferred embodiment of the present invention, the transducer is a piezoelectric transducer. Thereby, it is especially possible to use the same transducer for ejecting the droplets and for measuring the behaviour of the fluid inside the print head.

Another embodiment of the present invention is characterized in that the detection means is an electronic detection circuit assigned to the ink jet device or the detection means is a detection software assigned to the ink jet device. It is thereby possible to implement the measuring of the behaviour of the transducer and/or the behaviour of the fluid inside the print head by providing a detection circuit and/or by providing a software module detecting the behaviour of the print head.

According to the present invention it is further preferred that in order to eject a droplet out of the nozzle, an actuation pulse is applied by the transducer and wherein the detection means detects the behaviour of the transducer during and/or after the application of the actuation pulse. This can very preferably be done by applying a Fourier transformation to the signal of the transducer during or after the actuation pulse and by analysing the signal of the transducer in the frequency domain. More particularly, upon ejecting a droplet, the ensuing pressure and deformation waves are captured by the transducer, and a pressure time trace is preferably recorded. By Fourier transformation of such a trace in the time domain into a spectrum in the frequency domain, it becomes possible to deduce characteristic frequencies. According to the invention changes in the frequency spectrum may be attributed to changes in the state of the print head. Some of these changes occur gradually over time, which gives the ink jet and method according to the invention predictive power.

Very preferably, the inkjet device comprises a multi nozzle print head. Thereby, it is possible to eject a plurality of droplets out of one single print head. This speeds up the printing process.

It is much preferred according to the present invention to use an ink jet device where the ink jet device further comprises a print table and a printing bridge, the print table being mounted moveably relative to the printing bridge along a first direction and the print head being mounted to the printing bridge such that the print head is moveable relative to the printing bridge along a second direction. Thereby it is possible to print or deposit droplets of a substance to a large area of application such that the production of printed products can be made quite cost effective because large substrates or individual substrates can be printed as one batch.

According to the present invention, it is preferred that the substrate is a flat substrate, a structured substrate or a porous substrate. More preferably, the substrate is a nylon membrane, nitrocellulose, or PVDF substrate, or a coated porous substrate. Because the substrate is preferably porous, the spots or the droplets do not only lie on the surface, but also penetrate into the membrane.

In a still further embodiment of the present invention, the substrate comprises a plurality of substrate areas, each substrate area preferably being a separated membrane held by a membrane holder. Thereby, a plurality of separated membranes is possible to produce by the use of the inventive ink jet device.

Further preferably, the substrate comprises a plurality of substrate locations, the substrate locations being separated from each other at least the average diameter of a droplet positioned at one of the substrate locations. Thereby, it is possible to precisely and independently locate different droplets of a substance at precise locations on the substrate. It is also possible and advantageous to place a plurality of droplets on one and the same substrate location.

Very preferably the substance is a volatile solution in liquids like water, alcohols or glycerol and the like where different molecules or different compounds, especially bio-molecules are present.

The present invention also includes a method for monitoring the state of at least one print head of an ink jet device, which ink jet device is used for producing a biological assay substrate by releasing a plurality of substances onto the substrate, and which ink jet device comprises at least a print head provided with a nozzle, at least a transducer provided to eject a droplet out of the nozzle, and detection means for monitoring the state of the print head, which method at least comprises measuring the behaviour of the transducer. It is thereby possible to detect whether any relevant property of the printing process, and in particular the degree of filling of the print head and/or liquid reservoir, is out of bound, defective, changing to an undesired extent, and so on, and to determine whether action is required, such as refilling or replacing of the reservoir. The present invention may thus provide for a higher degree of accuracy of the printing process and may predict any future malfunctioning of the ink jet printer.

According to the present invention, it is preferred that the state of the print head is monitored by measurement of at least the deformation of the transducer. The deformation of the transducer is a characteristic able to detect in a reliable and repeatable manner many changes in the state of the print head.

According to another preferred embodiment of the present invention, the method is characterized in that the state of the print head is monitored by measuring at least one parameter related to the degree of filling of the reservoir of the print head. It is still more preferred that the at least one parameter is the impedance of the transducer and/or the gain of the transducer and/or the key tone frequency of the transducer. These parameters are easily accessible by means of the detection means assigned to the print head.

It is furthermore preferred according to the present invention that a droplet is ejected out of the nozzle by an actuation pulse applied by the transducer and wherein the detection means detects the behaviour of the transducer during and/or after the application of the actuation pulse and/or that a Fourier transformation of the behaviour of the transducer during and/or after the application of the actuation pulse is performed and analysed. Particularly preferred is a method wherein the at least one parameter is the gain of the transducer and/or the Helmholtz frequency of the transducer. It turned out that the Helmholtz frequency of the transducer is very sensitive to changes in the degree of filling of the liquid reservoir, and in particular to changes in the under pressure of the liquid reservoir.

It is preferred according to the present invention that a feed back loop stops the printing process if the analysis of the Fourier transformation of the behaviour of the transducer during and/or after the application of the actuation pulse cannot be related to a predefined reference signal and/or deviates from it a predefined amount. This has the advantage that the printing process is stopped when something goes wrong during printing (the feedback loop immediately interferes with the printing process) and that the substrate that is printed is marked (especially by a software) as “incorrect” and not considered as a good product. An operator may maintain the print head such that it operates according to the specifications and the printing process can then be resumed. In the software, the substrate, which is not correctly printed, is marked and removed out of the batch of printed membranes. Alternatively, the printing process may not be interrupted at all, but an operator may instead perform the corrective action necessary to remove the condition of non-conformance with the reference signal or spectrum.

The present invention also includes the use of an inventive ink jet device according to the present invention, wherein the substance comprises a biochemical reactant and/or a nucleic acid and/or a polypeptide and/or a protein. By using the inventive ink jet device for such a purpose, it is possible to very accurately print a certain number of substances on a substrate without an error to which substance is printed.

The present invention also relates to an assay substrate comprising a plurality of substances for biological analysis, which substrate may be obtained by the ink jet device and method of the present invention.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

In the figures

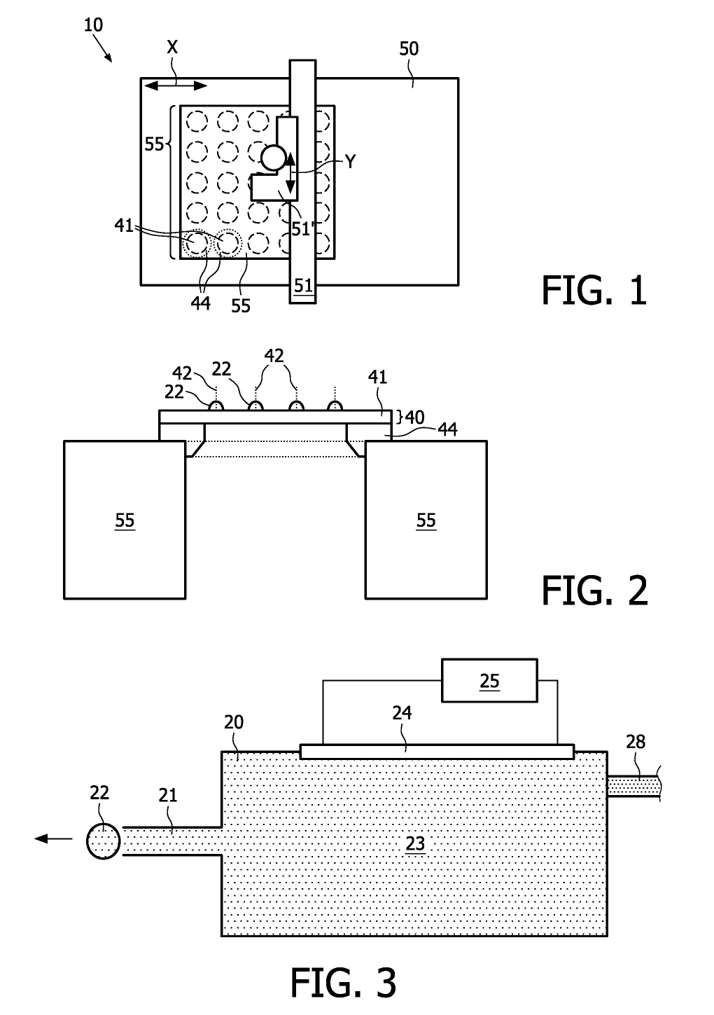

FIG. 1 illustrates schematically a top view of an embodiment of the ink jet device of the present invention;

FIG. 2 illustrates schematically a cross section through a substrate area and a membrane holder;

FIG. 3 illustrates schematically a print head with a nozzle and a detection means;

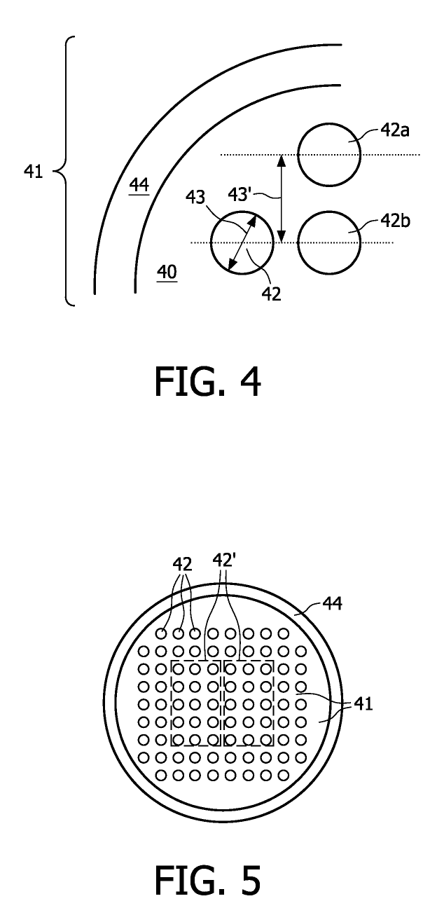

FIG. 4 illustrates schematically a part of a substrate area together with a membrane holder;

FIG. 5 illustrates schematically a complete membrane with membrane holder;

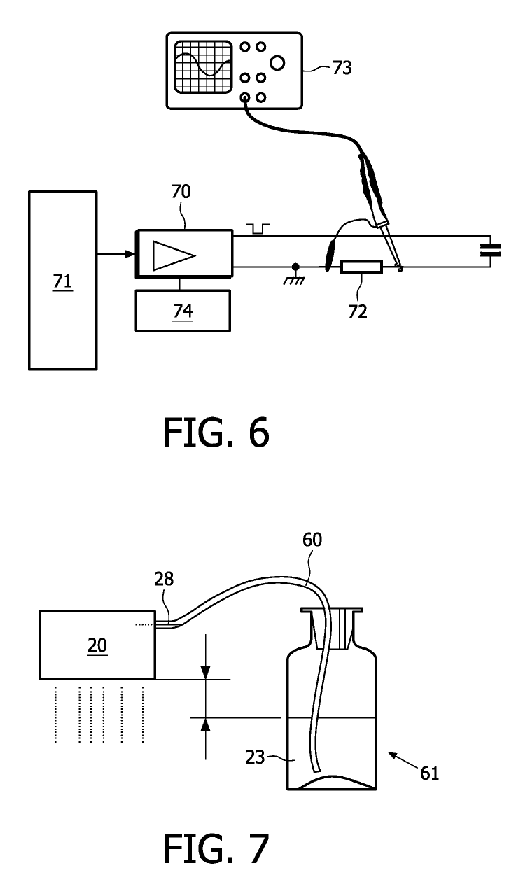

FIG. 6 illustrates schematically a preferred set-up to measure the deformation of the transducer;

FIG. 7 illustrates schematically an assembly of a fluid reservoir and a print head;

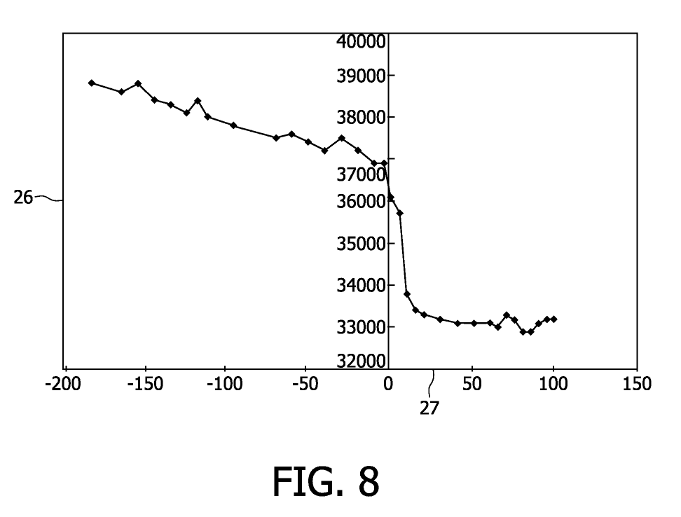

FIG. 8 finally schematically illustrates a measured parameter related to the degree of filling of the fluid reservoir and/or the value of the under pressure to control the meniscus position in the nozzle.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

In FIG. 1, a schematic top view of the ink jet device 10 according to the present invention is shown. On a print table 50 a fixture plate 55 is mounted on a linear stage allowing for motions in the X direction of the fixture plate 55. In this fixture plate 55, a number of membrane holders 44 with membranes 41 are positioned. The totality of the membranes 41 is referred to as the substrate 40. The membrane holder 44 may have any form but is basically only a ring 44. A round membrane 41 is welded onto this ring. So, after printing, the ring 44 with spotted membrane 41 together constitutes the final product. A printing bridge 51 is rigidly mounted relative to the print table 50. The printing bridge 51 carries the movable print head holder 51′. The stage with the fixture plate 55 is moveable along a first direction, the X-direction. A print head 20 is mounted to the movable print head holder 51′ such that it is moveably along a second direction, the Y-direction, relative to the printing bridge 51. According to the present invention, it is preferred, that the first direction (X-direction) and the second direction (Y-direction) are orthogonal. Thereby, the print head 20 can be positioned over a certain area of a print table 50 and can release droplets of a substance, which is stored in the print head 20 or in a reservoir (see FIG. 7) near the print head 20. The membranes 41 are mounted in the fixture plate 55, also called registration plate 55 at uniform distance in X-direction and uniform distance in Y-direction. The distance in X-direction may differ from the distance in Y-direction.

The substrate 40 may be made of a bio active membrane used for the detection of infectious diseases. Diagnostics of such diseases demands for a very high reliability of the printing process. The read out of the fluorescent pattern relates diseases directly to the positions of the specific capture probes. Therefore, it is absolutely necessary to have a very reliable process for the printing of the correct substance out of a plurality of different substances. Ink jet printing is a precision dosing technique without any feedback about the nature of the actually printed substance. By measuring the state of the print head 20, and preferably by measuring the state of the print head 20 continuously, it becomes possible to control and detect any (future) malfunction of the ink jet device and/or printing process. Printing errors can thereby be reduced considerably. The operator can for instance maintain the print head 20 such that it operates according to the specification.

The print table 50 is preferably provided in the form of a granite table. Alternatively, another very heavy material can also be used. According to the present invention, the print table 50 is preferably arranged in an environment, which has very little vibrational disturbances. A precision linear stage is mounted relative to the granite table (print table 50) and a fixture plate 55 mounted on the stage moves by definition in the first direction (X-direction). Another precision linear stage is mounted on the bridge 51 and guides the print head holder 51′ by definition in the second direction (Y-direction).

In FIG. 2, a schematic representation of a cross sectional view of an individual substrate membrane holder 44 and a part of the fixture plate 55 is shown. The membrane holder 44 carries one membrane 41. All membranes 41 together form substrate 40 (in FIG. 2, an accolade has been used to indicate this). One membrane 41 may also be called a substrate area 41. Each individual membrane holder 44 is located on the fixture plate 55 fixedly mounted on a linear stage allowing for a linear motion in the X-direction relative to the granite table (print table) 50. On the substrate 40, i.e. on each membrane 41, a plurality of substrate locations 42 are provided such that an individual dot (schematically shown by reference sign 22 in FIG. 2) is able to be located at a distance from one another. A dot can be formed out of one droplet dispensed by the print head or is built-up out of a plurality of droplets of the same substance. Thereby, it is possible to dispense or to position a different kind of substance on each of the substrate locations 42.

In FIG. 3, a print head 20 with a nozzle 21 and a detection means 25 is schematically shown. The print head 20 comprises a transducer 24. The transducer 24 is preferably a piezoelectric transducer 24. Generally, an electromechanical transducer 24 being able to provide mechanical waves inside the print head 20 can be used as a transducer 24. The transducer 24 can be actuated by an activation pulse (not shown) provided by a control unit (not shown). The detection unit 25 or detection means 25 is able to detect the behaviour of the transducer 24 which is in turn influenced by the behaviour of the print head 20 and/or the print head 20 together with the fluid or the substance 23 inside the print head 20. Print head 20 is provided with a further duct or throttle 28, through which substance 23 can be supplied.

According to the present invention, a plurality of substances 23 can be filled inside of the print head 20. This is for example done by means of a further duct 60 (shown in FIG. 7), which is connected to the throttle 28 of the print head 20. A vacuum pump (not shown) can be connected, if desired. The reservoir 61 is positioned such that the nozzle(s) 21 are at a certain distance (usually a few to ten cm liquid column) below the level of the liquid in reservoir 61. In that way a constant and very well controlled under pressure can be set to control the meniscus position in the nozzle(s) 21. In another embodiment the under pressure to control the meniscus position in the nozzle 21 is controlled by a vacuum pump (not shown). To print the substance 23 transducer 24 is actuated by an actuation pulse such that a droplet 22 is ejected from the nozzle 21 of the print head 20. During the actuation pulse and/or after the actuation pulse a measurement of the behaviour of the print head 20 and/or the transducer 24 is performed by the detection means 25. The detection means 25 is provided preferably in the form of a circuit and/or a software module being able to provide and/or measure parameters related to a property of the substance 23 inside the print head 20. According to the invention, the measured property is preferably the degree of filling of the reservoir 61. By detecting the different degrees of filling for different print heads 20 acoustically, i.e. by means of detecting the (acoustical) behaviour of the print head 20 connected to a reservoir 61 with a certain degree of filling, it is possible to check (at every time during the printing process and especially directly during and/or after printing an individual droplet) whether there is still enough fluid or substance 23 available for printing on the right spot or substrate location.

In FIG. 4, a part of a membrane 41 or a substrate area 41 is shown from the top. On the substrate area 41 are defined a plurality of substrate locations 42, 42a, 42b. The substrate locations 42, 42a, 42b are the locations, where the droplets 22 are to be positioned by the ink jet device 10 according to the present invention. Is it also possible to place a plurality of droplets of the same substance on one single substrate location 42. The droplets 22 which have been ejected by the print head 20 and landed on the substrate 40 will cover a certain dot area or spot around the substrate locations 42, 42a, 42b with an average diameter 43 which is lower than the respective distance 43′ (or pitch) of the substrate locations 42, 42a, 42b from one another. On a substrate area 41, for example 130 spots or substrate locations 42 can be provided where droplets 22 can be printed, each droplet needing a volume of, e.g., around 1 nl. The diameter 43 of the spots or the droplets 22 is for example 200 μm and they are placed in a pattern with a pitch of, e.g., 400 μm. Of course, it is also possible to provide more (up to 1000) and smaller spots necessitating only a smaller pitch of, for example, 300 μm or only 200 μm, 100 μm or 50 μm. The 130 spots are printed for example with one single print head 20, which is provided with different substances 23. For example, on the fixture plate 55, 140 pieces of membrane holders 44 are arranged which are processed in one batch of printing by the ink jet device 20. The pitch 43′ of the droplet spots is provided in the range of 10 to 500 μm according to the present invention. The diameter 43 of the spots of the droplets 22 is in the range of about 20% to 70% of the actual pitch 43′. The volume of the droplets 22 has to be adapted to the preferred size of the spot and to the material of the substrate 40 used (e.g. dependent of where the substrate strongly or weakly absorbs the substance applied). Typically, the volume of the droplets 22 is about 0.001 nl to 10 nl.

In FIG. 5 a top view of a substrate area 41 obtainable by the ink jet device and method of the present invention is shown. In the embodiment shown, a plurality of substrate locations 42 are represented by small circles. It is possible although not necessary to position many different substances on these different substrate locations 42 in order to use the membrane of the substrate area 41 for diagnostic purposes. Likewise it is possible to define several groups 42′ of substrate locations 42 in order to perform a complete set of tests within one group 42′ of substrate locations 42 and their respective substances. By continuously monitoring the printing process according to the invention, a substrate may be produced accurately and reliably, minimizing the occurrence or even avoiding misprints as much as possible.

An essential feature of the present invention is the measurement—by means of the detection means—of the acoustic response just by using the transducer 24 of the print head 20 as a pressure sensor. Thereby, no extra means have to be built in the print head 20. In FIG. 6, an embodiment of an electronic circuit is shown, which circuit may be used in connection with the ink jet device of the present invention. The print head 20 is connected to its own driving system comprising an amplifier 70 provided with its voltage source 74 and a serial to parallel converter (not shown) to transfer the serial information coming from the computer 71 to parallel control of a number of nozzles 22. In FIG. 6 only one nozzle is shown, but it should be understood that the electrical circuit also holds for multi-nozzle addressing, by carrying out the measurements in parallel. In the electrical connections to the piezoelectric actuator 24 needed to pressurise the fluid 23 inside the pump chamber to eject droplets 22 a resistor 72 is mounted. Resistor 72 is preferably chosen such that the pulse shape coming out of the amplifier 70 is hardly changed and that the current needed to charge the piezoelectric actuator 24 and the return signal from the piezoelectric sensor 25 can be recorded sufficiently accurate. The resistor signal is preferably measured onto the common side, as indicated in FIG. 6, since this avoids the occurrence of high voltage changes, which may damage the equipment. Moreover measurement of the acoustic response of the actuator on the common side enables to magnify the voltage sweep such that all details of the acoustic signal may easily be detected. The recorded voltage signal over the resistor 72 is send to an oscilloscope or preferably to a personal computer 73 adapted to be used as a digital oscilloscope and frequency response analyser. The sensitivity of the pressure (or acoustic) signal may vary between broad ranges but is typically of the order of about 0.2 to 1.5 Volt/bar.

In a typical method, the signal recorded by the piezoelectric transducer 24 is measured by the computer 73 directly after a pulse has been fired, causing droplet ejection. The recorded time trace is then transformed into a Fourier spectrum. A particular frequency window may then be selected to analyse the data. Although frequencies may comprise the ultrasonic range, a typical spectrum is analysed between about 0 and 200 kHz, as this window incorporates the most interesting frequencies for detecting changes associated with changes in the state of the print head. The spectrum is then compared to a reference spectrum, which corresponds to a properly working print head. When a change is recorded, for instance due to an empty print head, the presence of an air bubble or a failing under pressure control, immediate action can be taken to refill the print head or to start any procedure to get the print head in proper condition again, such as refilling and purging, and/or cleaning and wiping of the nozzle plate. Acoustic testing of the print head opens the possibility to detect upfront whether a print head or a nozzle of a print head will fail in the near future. In other words the present invention allows to predict what will happen with the print head or a nozzle of such a head, when a change in a recorded pressure trace or the corresponding Fourier transform has been detected. In case a plurality of different substances are continually printed on a series of substrates the device and method yields information about the course of the whole printing process. In case one or more nozzles start to fail for a particular substance, immediate action can be undertaken. Several possible actions may be taken. For instance, the printing process may be stopped and the print head maintained in such a manner that all nozzles work properly again. The substrates that were printed incorrectly may be marked by the software and taken out of the batch after the whole print process of all the different fluids is ready. It is also possible to stop the printing process and maintain the print head in such a manner that all nozzles work properly again. In this case the system has stored the erroneous substrates and restarts and first repairs the wrongly printed spots. Another case is when each fluid is printed by two print heads. These two print heads work in unison, performing the same actions on the substrates to be printed. At the very moment one nozzle of one print head fails the corresponding nozzle of the other print head takes over, e.g. by doubling its droplet frequency. Another possible measure is to bring down the line speed. In that way printing can be continued till the batch is ready. Before resuming with printing of the next batch the print heads can be maintained such that all nozzles will work properly again. In still another embodiment of the method, all acoustic information about the printing process is stored. For traceability afterwards it can be checked whether all spots are printed correctly in the sense that the amount of fluid needed per spot has indeed been dispensed. Each fluid has its own characteristic behaviour as far as printing settings are concerned, like pulse shape (pulse height in volts and pulse length in microseconds), droplet frequency and meniscus under pressure. Acoustic testing according to the present invention can give information about issues like for instance:

A too high driving frequency, which may lead to cavitation;

A too high meniscus under pressure, which may hamper refilling after droplet emission;

A too low meniscus under pressure, which may lead to flooding of the nozzle plate;

A too high viscosity, which may hamper refilling due to flow resistance;

A too low viscosity, which may lead to poor damping.

Based on this information, the system can adapt itself in such a sense that the printing process can proceed with other settings. In case of cavitation for instance a lower droplet frequency could be used, in case of poor refilling a lower value of the meniscus under pressure setting may be selected. When the damping is poor or when the viscosity is too high, a lower driving frequency could be selected as a remedy.

As an example, FIG. 8 shows the dependence of the gain 26 at the Helmholtz frequency on the static pressure 27 of the print head, measured in mm of substance. The larger the under pressure 27 the higher the Helmholtz frequency (please note that with larger under pressure is meant a more negative pressure). When the meniscus under pressure approaches zero the nozzle plate floods. This results in a quite drastic decrease of the Helmholtz frequency. The Helmholtz frequency is easily detectable from the recorded pressure trace by methods known to the skilled person.

1. Ink jet device (10) for producing a biological assay substrate (40) by releasing a plurality of substances (23, 23a, 23b) onto the substrate (40), the device (10) comprising at least a print head (20) comprising a nozzle (21), the device (10) comprising at least a transducer (24) provided to eject a droplet (22) out of the nozzle (21), wherein a detection means (25) is assigned to the ink jet device (10) such that the state of the print head (20) can be monitored by means of the detection of the behaviour of the transducer (24).

2. Ink jet device (10) according to claim 1, wherein the state of the print head (20) comprises the degree of filling of the reservoir of a print head (20).

3. Ink jet device (10) according to claim 1, wherein the state of the print head (20) is monitored by means of a measurement of the deformation of the transducer (24).

4. Ink jet device (10) according to claim 3, wherein the state of the print head (20) is monitored by means of a measurement of the deformation of the transducer (24) upon ejecting the droplet (22) out of the nozzle (21).

5. Ink jet device (10) according to claim 1, wherein the transducer (24) is a piezoelectric transducer (24).

6. Ink jet device (10) according to claim 1, wherein the detection means (25) is an electronic detection circuit assigned to the ink jet device (10) or wherein the detection means is a detection software assigned to the ink jet device (10).

7. Ink jet device (10) according to claim 1, wherein in order to eject a droplet (22) out of the nozzle (21), an actuation pulse is applied by the transducer (24) and wherein the detection means (25) detects the behaviour of the transducer (24) during and/or after the application of the actuation pulse.

8. Ink jet device according to claim 1 wherein the inkjet device (10) comprises a multi nozzle print head (20).

9. Ink jet device (10) according to claim 1, wherein the ink jet device (10) further comprises a print table (50) and a printing bridge (51), a stage with fixture plate (55) movably relative to the print table (50) along a first direction (X-direction) and the print head (20) mounted on a movable print head holder being mounted to the printing bridge (51) such that the print head (20) is movable relative to the printing bridge (51) along a second direction (Y-direction).

10. Ink jet device (10) according to claim 11, wherein the first direction (x-direction) and the second direction (Y-direction) are orthogonal.

11. Ink jet device (10) according to claim 1, wherein the substrate (40) is a flat substrate, a structured substrate, a coated substrate or a porous membrane (41), preferably a nylon membrane.

12. Ink jet device (10) according to claim 1, wherein the substrate (40) comprises a plurality of substrate areas (41), each substrate area (41) preferably being a separated membrane (41) held by a membrane holder (44).

13. Ink jet device (10) according to claim 1, wherein the substrate (40) comprises a plurality of substrate locations (42, 42a, 42b), the substrate locations (42, 42a, 42b) being separated from each other by at least the average diameter (43) of a droplet (22) positioned at one of the substrate locations (42, 42a, 42b).

14. Ink jet device (10) according to claim 1, wherein a plurality of droplets (22) are superposed on one substrate location (42, 42a, 42b).

15. Method for monitoring the state of at least one print head (20) of an ink jet device (10), which ink jet device (20) is used for producing a biological assay substrate (40) by releasing a plurality of substances (23, 23a, 23b) onto the substrate (40), and which ink jet device (10) comprises at least a print head (20) provided with a nozzle (21), at least a transducer (24) provided to eject a droplet (22) out of the nozzle (21), and detection means (25) for monitoring the state of the print head (20), which method at least comprises measuring the behaviour of the transducer (24).

16. Method according to claim 15, wherein the method at least comprises measuring the deformation of the transducer (24).

17. Method according to claim 15, wherein the state of the print head (20) is monitored by measuring at least one parameter (26, 27) related to the degree of filling of the reservoir of the print head (20).

18. Method according to claim 15, wherein the state of the print head (20) is monitored by measuring at least one parameter (26, 27) related to the under pressure controlling the meniscus in the nozzles (21).

19. Method according to claim 17, wherein the at least one parameter (26, 27) is the impedance of the transducer (24).

20. Method according to claim 17, wherein the at least one parameter (26, 27) is the gain (26) of the transducer (24) and/or the Helmholtz frequency (27) of the transducer (24).
